(19) United States
(12) Patent Application Publication
(10) Pub. No.: US 2011/0123117 A1
(43) Pub. Date: May 26, 2011

(54) Searching and Extracting Digital Images From Digital Video Files

(76) Inventors: Brian D. Johnson, Portland, OR (US); Michael J. Espig, Newberg, OR (US); Suri B. Medapati, San Jose, CA (US)

(21) Appl. No.: 12/623,969

(22) Filed: Nov. 23, 2009

(51) Int. Cl. H04N 7/00; G06F 17/30; G06K 9/46; G06K 9/66

(52) U.S. Cl. 382/190; 707/769; 707/E17.014

(57) ABSTRACT

An object depicted with a video file may be located in a search process. The located object may then be extracted from the digital video file. The extracted depiction may then be modified independently of the video file.

### BACKGROUND

This relates generally to devices for processing and playing video files.

Video information in electronic form may be played by digital versatile disk (DVD) players, television receivers, cable boxes, set top boxes, computers, and MP3 players, to mention a few examples. These devices receive the video file as an atomic unit with unparseable image elements.

### BRIEF DESCRIPTION OF THE DRAWINGS

FIG. 1 is a depiction of an apparatus in accordance with one embodiment;

FIG. 2 is a flow chart for one embodiment; and

FIG. 3 is a depiction of a metadata architecture in accordance with one embodiment.

### DETAILED DESCRIPTION

In accordance with some embodiments, a digital video file may be broken down into constituent depicted digital images. Those digital images may be separated from the rest of the digital video file and manipulated in various ways. In some embodiments, the digital video file may be pre-coded with metadata to facilitate this operation. In other embodiments, after the video file has been made, it may be analyzed and processed to develop this kind of information. For example, information associated with a digital video file, including associated text including titles that are not part of the digital video file, may also be used. In still another embodiment, in the course of searching digital video files for particular types of objects, the objects may be identified within the digital video file in real time.

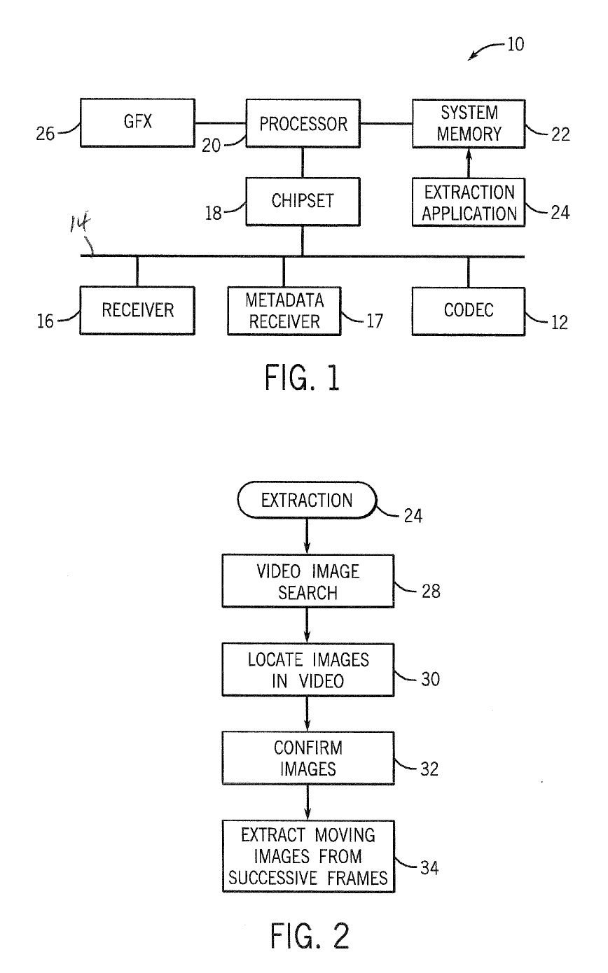

Referring to FIG. 1, in accordance with one embodiment, a computer 10 may be a personal computer, a mobile Internet device (MID) a server, a set top box, a cable box, a video playback device, such as a DVD player, a video camera, or a television receiver, to mention some examples. The computer 10 has the ability to process digital video for display, for further manipulation, or for storage, to mention a few examples.

In one embodiment, the computer 10 includes a coder/decoder (CODEC) 12 coupled to a bus 14. The bus 14 is also coupled to a video receiver 16. The video receiver may be a broadcast receiver, a cable box, a set top box, or a media player, such as a DVD player, to mention a few examples.

In some cases, metadata may be received by the metadata receiver 17, separately from the receiver 16. Thus, in some embodiments that use metadata, the metadata may be received with the digital video file and, in other embodiments, it may be provided out of band for receipt by a separate receiver, such as the metadata receiver 17.

The bus 14 may be coupled, in one architecture, to a chipset 18. The chipset 18 is coupled to a processor 20 and a system memory 22. In one embodiment, an extraction application 24 may be stored in the system memory 22. In other embodiments, the extraction application may be executed by the CODEC 12. In still other embodiments, an extraction sequence may be implemented in hardware, for example, by the CODEC 12. A graphics processor (gfx) 26 may be coupled to the processor 20.

Thus, in some embodiments, an extraction sequence may extract video images from a digital video file. The nature of the content in the digital video file encompasses movies, advertisements, clips, television broadcasts, and podcasts, to give a few examples. The sequence may be performed in hardware, software, or firmware. In the software based embodiment, it can be accomplished by instructions executed by a processor, controller, or computer, such as the processor 20. The instructions may be stored in a suitable storage, including a semiconductor, magnetic, or optical memory, such as the system memory 22, as one example. Thus, a computer readable medium, such as a storage, may store instructions for execution by a processor or other instruction execution entity.

Referring to FIG. 2, the sequence 24 begins with a video image search, as indicated in block 28. Thus, in some embodiments, a user may enter one or more search terms to locate an object of interest which may be depicted in a digital video file. A search engine may then implement a search for digital video files containing that information. The search, in one embodiment, may be accomplished using key word searching. The text that may be searched includes metadata associated with the digital video file, titles, and text related to the digital video file. In some cases, the search may be automated. For example, a user may run an ongoing search for topics, persons, or objects of interest, including such items contained in digital video files.

In some embodiments, digital video files may be associated with metadata or additional information. This metadata may be part of the digital video file or may be separate therefrom. The metadata may provide information about the video file and the objects depicted therein. The metadata may be used to locate objects of interest within an otherwise atomic and unparseable digital video file. The additional information includes any data that is not part of the file, but which can be used to identify objects in the file. It may include descriptive text, including titles associated with the digital video file.

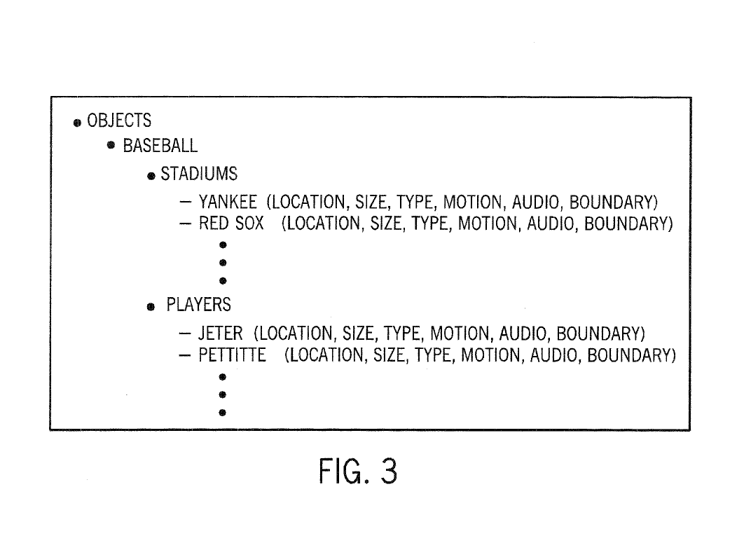

Thus, as an example, referring to FIG. 3, the metadata may be organized by various objects that are depicted within the video file. The metadata, for example, may have information about baseball objects and under baseball may be information about stadiums and players depicted in the file. For example, under stadium, object descriptions such as Yankee Stadium and Red Sox Stadium may be included. Each of these object depictions may be associated with metadata that gives information about one or more of the object's location, size, type, motion, audio, and boundary conditions.

By “location,” it is intended to refer to the frame or frames in which the object is depicted and, in some cases, more detailed coordinates of the object's location within each frame. With respect to size, the object's size may be given in terms of numbers of pixels as one example. Type may be whether the object is a person, a physical object, a stationary objection, or a moving object, as examples.

Also indicated is whether or not there is motion in the file and, if so, what type of motion is involved. For example, motion vectors may give the information about the direction and how much the object will move between the current and the next frame. The motion information may also indicate where the object will end up in the sequence of frames that make up the digital video file, as another example. The motion vectors may be extracted from data already available of use in video compression.

The metadata may also include information about the audio associated with the frames in which the object is depicted. For example, the audio information may enable the user to obtain the audio that plays during the depiction of the object of interest. Finally, the boundary conditions may be provided which give the boundaries of the object of interest. Pixel coordinates of boundary pixels may be provided, in one embodiment. With this information, the object's location, configuration, and characteristics can be defined.

Thus, in some embodiments, when the video file is being made or recorded, an organization or hierarchy of metadata of the type shown in FIG. 3 may be recorded in association with the file. In other cases, a crawler or processing device may process existing digital video files to identify pertinent metadata. For example, such a crawler may use object identification, or object recognition and/or object tracking software. It may be able to identify groups of pixels as being associated with an object based on information that it has about what different types of objects look like and what are their key characteristics. It may also use Internet searching to find objects that it believes represent the object in question, either based on associated text, analysis of associated audio or other information. Such searching may also include social networking sites, shared databases, wikis, and blogs. In such case, a pattern of pixels may be compared to a pattern of pixels in objects that are known to be identified as a particular object to see whether the pixels in the digital file correspond to that known, identified object. This information may then be stored in association with the digital file, either as a separate file or within the digital video file itself.

As still another alternative, when a user wishes to find a particular object within any digital video file, a number of digital video files may be analyzed to assemble the metadata described in FIG. 3.

Referring again to FIG. 2, once a digital video file has been identified which may have the object of interest, the object may be located with the video file, either using preexisting metadata or by analyzing the file to develop the necessary metadata, as indicated in block 30. Then, in block 32, the identification of the object within the digital video file may be confirmed in some embodiments. This may be done by using secondary information to confirm the identification. For example, if the object depicted is indicated to be Yankee Stadium, a search on the Internet can be undertaken to find other images of Yankee Stadium. Next, the pixels in the video file may be compared to the Internet images to determine whether object recognition can confirm the correspondence between a known depiction of Yankee Stadium and the depiction within the digital video file.

Finally, the object within the digital video file may be extracted from each frame in which the object appears, as indicated in block 34. If the location of the pixels corresponding to the images are known, they can be tracked from frame to frame. This may be done using image tracking software, image recognition software, or the information about the location of the object in one frame and information about its movement or motion therefrom.

Then the pixels associated with the object may be copied and stored as a separate file. Thus, for example, a depiction of a particular baseball player in a particular baseball game may be extracted the first time the player appears. The player's depiction may be extracted without any foreground or background information. Then a series of frames, showing the movement, motion, and action of that particular baseball player, are located thereafter. Some frames where the player does not appear may end up blank in one embodiment. The audio associated with the original digital video file may play as if the full depiction were still present, in one embodiment, by extracting the associated audio file using information about the audio within the metadata.

Once these series of images has been extracted, these images can then be further processed. They may be resized, they may be re-colored, they be modified in a variety of ways. For example, a series of two dimensional images may be converted into three dimensional images using processing software. The extracted images may be dropped into a three dimensional depiction, added to a web page, or a social networking site, as additional examples.

A new video file may be created by combining other images with the extracted object. This may be done, for example, using image overlay techniques. A number of extracted moving objects may be overlaid so that they appear to interact over a series of frames in one embodiment.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
locating an object depicted in a series of frames of a digital video file: and
extracting pixels depicting that object from the video file.

2. The method of claim 1 including locating an object by searching metadata associated with said file.

3. The method of claim 1 including searching metadata that is part of same video file for said object.

4. The method of claim 1 including searching metadata for said video file in a file separate from said video file.

5. The method of claim 1 including analyzing said video file to create metadata identifying the location of an object depiction in the video file.

6. The method of claim 1 including providing metadata indicating the extent and direction of movement of a depicted object in said video file.

7. The method of claim 1 including converting an extracted two dimensional depiction of the object into a three dimensional depiction.

8. A computer readable medium storing instructions executed by a computer to:
extract an object image depicted in a video file from the video file.

9. The medium of claim 8 further storing instructions to conduct a search for the image in said video file.

10. The medium of claim 9 further storing instructions to use metadata associated with the video file to locate said image.

11. The medium of claim 8 further storing instructions to extract a moving object image from a series of frames in said video file.

12. The medium of claim 8 further storing instructions to extract pixels depicting said image from said video file.

13. An apparatus comprising:
a processor;
a coder/decoder coupled to said processor; and
a device to extract a moving object image from a digital video file.

14. The apparatus of claim 13, said device to extract an object image from a plurality of frames, said object image moving in said frames.

15. The apparatus of claim 13, said device to search a digital video file for a selected object.

16. The apparatus of claim 15, said device to conduct a keyword search through a digital video file.

17. The apparatus of claim 13, said device to use metadata associated with said digital video file to locate said object image.

18. The apparatus of claim 13, said device to extract pixels depicting said moving object image from said digital video file.

19. The apparatus of claim 13 including a receiver to receive a digital video file.

20. The apparatus of claim 19, said apparatus including a receiver to receive out-of-band metadata associated with said digital video file.
